(19) United States
(12) Patent Application Publication
(10) Pub. No.: US 2006/0013927 A1
(43) Pub. Date: Jan. 19, 2006

(54) Radio frequency electric field pasteurization system

(76) Inventors: David J. Geveke, Brookhaven, PA (US); Christopher D. Brunkhorst, Oxford, NJ (US); Andrew B. W. Bigley, Levittown, PA (US)

Correspondence Address: UNITED STATES DEPARTMENT OF ENERGY, 1000 INDEPENDENCE AVENUE, S.W., ATTN: GC-62 (CHI), MS 6F-067, WASHINGTON, DC, 20585-0162, US

(21) Appl. No.: 11/066,653

(22) Filed: Jun. 28, 2005

Related U.S. Application Data
(60) Provisional application No. 60/588,344, filed on Jul. 16, 2004.

(51) Int. Cl. A21D 6/00

(52) U.S. Cl. 426/237; 426/521

(57) ABSTRACT

The present invention relates to a cost effective, non thermal pasteurization system that effectively treats liquid foods using radio frequency electric fields “RFEFs”. One embodiment of the system operates by flowing liquid food products through a treatment chamber or a series of treatment chambers wherein the liquid food is exposed to high strength, uniform RFEFs for very short periods of time (i.e. less than 1 second). The treatment chamber is designed to apply a uniform and concentrated RFEF to the liquid food being treated. The system can be designed to incorporate recycling to increase the effectiveness. Suitable field strengths, treatment times and frequencies are provided.

### RELATION TO OTHER APPLICATIONS

The present application claims priority of U.S. Provisional Patent Application No. 60/588,344 filed Jul. 16, 2004 by instant inventors. The above-identified provisional application is hereby incorporated by reference in its entirety.

### U.S. GOVERNMENT RIGHTS

The United States Government has rights in this invention pursuant to Contract No. DE-AC02-76CH03073 between the U.S. Department of Energy and Princeton University. Furthermore, inventors Geveke and Bigley are government employees of the United States Department of Agriculture.

### TECHNICAL FIELD

The present invention relates to a non-thermal pasteurization system. More specifically the invention relates to a pasteurization system incorporating a special chamber designed to apply uniform radio frequency electric fields to liquid food products.

### BACKGROUND OF INVENTION

Nearly all fruit juice is pasteurized to ensure its safety. Pasteurization typically involves heating the juice to a high temperature and holding for a sufficient length of time. Although heat pasteurization is effective at inactivating pathogenic microorganisms, it also alters the properties of the juice. Extensive research has been conducted on nonthermal processes that inactivate microorganisms without damaging the original attributes of the juice. For more than 15 years, high electric fields in liquid foods have been studied (Dunn J E, Pearlman J S, inventors; Maxwell Laboratories, assignee. 1987 Sep. 22. Methods and apparatus for extending the shelf life of fluid food products). Pulsed electric fields (“PEF”) at 35 kV/cm have been applied to orange juice for 59 μs at 60° C. and the quality of the juice was compared with that of juice pasteurized with hot water. (Yeom H W, Streaker C B, Zhang Q H, Min D B. 2000. Effects of pulsed electric fields on the quality of orange juice and comparison with heat pasteurization. J AgricFood Chem 48(10):4597-605). The PEF treatment prevented microorganism growth at 37° C. for 112 days and the PEF-treated juice retained more of the vitamin C and flavor compounds than the heat-treated juice.

Nonetheless, PEF treatment processes have yet to be commercialized. The reasons for this are mainly economic. The energy requirement for complete pasteurization using PEF is estimated at 100-400 J/ml (Schoenbach K H, Katsuki S, Stark R H, Buescher E S, Beebe S J. 2002. Bioelectrics—new applications for pulsed power technology. IEEE Trans Plasma Sci 30(1):293-300). By comparison, thermal pasteurization with heat regeneration requires as little as 30-40 J/ml. PEF equipment is extremely specialized. The high cost of the pulse generator is a problem confronting the industrial application of PEF processing. At a high pulse frequency and large scale of operation for industrial applications, the charging power supply and high speed electrical switch are the major costs of the pulse generator (Zhang Q, Barbosa-Canovas G V, Swanson B G. 1995a. Engineering aspects of pulsed electric field pasteurization. J Food Eng 25(2):261-81). To date, several PEF systems have been developed.

U.S. Pat. Nos. 5,393,541 ('541) and 5,235,905 ('905) issued to Bushnell, et al., describe systems for preserving liquid food products using very high strength electric field pulses of at least 500 v/cm for very short duration. While the Bushnell '541 and '905 systems produced satisfactory results they rely on pulsed electric fields which are expensive to produce. Furthermore, using pulsed electric fields limits one's ability to control the frequency of the electric field which is important.

U.S. Pat. No.6,110,425 ('423) issued to Bushnell, et al., teaches an system for deactivating microorganisms in food products using pulsed electric fields combined with a specialized converging treatment apparatus. The Bushnell '423 system relies solely on PEF and does not teach or suggest the use of RFEF. Furthermore, Bushnell's '423 system does not allow one to adjust and control the frequency of the electric field which is an important aspect of successful RFEF treatment.

U.S. Pat. No. 5,609,900 issued to Reznik, discloses a method and apparatus for treating food products using electric fields. The Reznik system treats the food products by electroheating which negatively affects the food's taste and quality.

Radio frequency electric fields (“RFEF”) processing is similar to PEF processing in that high electric fields are applied to liquids for extremely short durations at moderately low temperatures in order to inactivate microorganisms by electroporation (Zimmermann U. 1986. Electrical breakdown, electropermeabilization and electrofusion. Rev Physiol Biochem Pharmacol 105:176-256). Whereas a PEF generator comprises a charging power supply and high speed electrical switch, a RFEF generator consists of an AC power supply. This makes RFEF much more cost effective than PEF systems. Previous attempts at pasteurization using RFEFs produced mixed results. The present inventors have previously documented the ability of RFEF to kill microorganisms in water, however, the previous system was insufficient for use in pasteurizing liquid food products like fruit juice for several reasons including the higher conductivity of liquid foods like juice compared with water. (Geveke D J, Brunkhorst C. 2003. Inactivation of Saccharomyces cerevisiae using radio frequency electric fields. J Food Prot 66(9):1712-5).

There is a need in the art for a non-thermal, or low heat, pasteurization system that will effectively treat liquid foods such as fruit juice while retaining the beneficial attributes of fresh food products. More specifically, there is a need for a cost effective electric field pasteurization system to treat liquid food products using a uniform RFEF having a defined maximum field strength and frequency.

### SUMMARY OF THE INVENTION

The present invention relates to a cost effective, non thermal pasteurization system that effectively treats liquid foods using RFEFs. One embodiment of the system operates by flowing liquid food products through a treatment chamber or a series of treatment chambers wherein the liquid food is exposed to a near uniform, high strength RFEF (i.e. greater than 10 kV/cm) for very short periods of time (i.e. less than 0.01 second). The treatment chamber is designed to apply a uniform and concentrated RFEF to the liquid food being treated. The system can be designed to incorporate recycling to increase the effectiveness. Suitable field strengths, treatment times and frequencies are provided.

A further embodiment of the present invention relates to a method of deactivating microorganisms using a uniform RFEF of defined strength and frequency.

A general object of the present invention is to provide a non-thermal pasteurization system that effectively kills microorganisms in liquid foods.

Another general object of the present invention is to provide a non-thermal and/or moderately low temperature pasteurization system that effectively treats liquid foods while retaining many of the beneficial attributes of fresh foods.

Yet another general object of the present invention is to provide a pasteurization system that is both easy to construct and which is cost effective.

Another general object of the invention is to provide a pasteurization system utilizing RFEF to attain a ≧5log decrease in microorganisms in a liquid food product.

Another general object of the present invention is to provide a pasteurization system that can be combined with other food treatment methods and systems to improve treatment effectiveness, and/or extend shelf life.

One embodiment of the present invention utilizes a RFEF and a converged treatment chamber to non-thermally treat liquid food products.

One embodiment of the present invention describes a pasteurization system having a means for treating liquid food with a near uniform RFEF.

One embodiment of the present invention utilizes a RFEF having a field strength between 10-200 kV/cm

Another embodiment of the present invention utilizes a RFEF having a field strength of at least 10 kV/cm.

Another embodiment of the present invention utilizes a RFEF having a frequency between 15-80 kHz.

One embodiment of the present invention utilizes a RFEF having a frequency less than 20 kHz.

One embodiment of the present invention utilizes a RFEF having a frequency of at least 10 kHz.

Yet another embodiment of the present invention utilizes a series of RFEF treatment stages.

Yet another embodiment of the present invention utilizes a number of RFEF treatment chambers aligned in parallel.

Another embodiment of the present invention utilizes more than one treatment cycle to treat the liquid food product.

Another embodiment of the present invention utilizes a unique RF power source.

### BRIEF DESCRIPTION OF THE DRAWINGS

FIG. 1 is a schematic diagram of one embodiment of the RFEF system

FIG. 2 is an electrical diagram of the RF system

FIG. 3 is a cross-section of the RFEF converged treatment chamber.

FIG. 4 shows modeled anisotropic AC current flow within the treatment chamber.

FIG. 5 illustrates the effects of temperature and electric field strength on the inactivation of E. coli in apple juice at 20 kHz and with a 4-s hold time. Error bars indicate standard deviations.

FIG. 6 illustrates the effect of temperature alone on the inactivation of E. coli in apple juice with a 8 s hold time.

FIG. 7 illustrates the effect of frequency on the inactivation of E. coli in apple juice at 20 kV/cm with a 4-s hold time at 50° C. Error bars indicate standard deviations.

FIG. 8 illustrates the effect of the number of treatment stages on the inactivation of E. coli in apple juice at 50° C., 20 kHz, and 18 kV/cm with a 4-s hold time. Error bars indicate standard deviations.

FIG. 9 is an electrical diagram of an alternative RF system.

### DETAILED DESCRIPTION OF THE EMBODIMENTS

The present invention describes a non-thermal pasteurization system that effectively deactivates microorganisms in liquid foods by applying a uniform radio frequency electric field of specified strength to a food stock passing through it. Various embodiments of this system are described below, however, the scope of the invention should be determined by the claims.

Definitions

Food product, feed stock, liquid food product and liquid feed stock are defined as edible food products including but are not limited to: fluid or semi-fluid products like beverages, gravies, sauces, soups and fluid dairy products such as milk, food containing slurries like stews, and gelatinous foods like eggs.

The terms inactivation, deactivation (of organisms) and similar phrases are defined as killing or preventing replication of organism such as bacteria, viruses, parasites, and fungi.

Treatment time is the amount of time the food product is exposed to high strength radio frequency electric fields.

Hold time refers to the amount of time between the RFEF treatment of the food product and cooling of the product by, for instance, a heat exchanger.

RF power source refers to the device that generates power at radio frequencies, and delivers that power at appropriate voltages to the food being processed.

Preferred Embodiments

The invention generally comprises: at least two electrodes, a RF power source and an insulated section positioned between two electrodes, wherein the insulated section has a cavity running the length of the insulated section allowing the flow of food product through the insulated section. The RF power source supplies a voltage to the pair of electrodes creating a RFEF between the electrodes that electroporates microorganisms present in the food stock passing through system. The diameter of the insulated section's cavity narrows along the length of the insulator pinch forming a concentrated and uniform electric field within the pinch region.

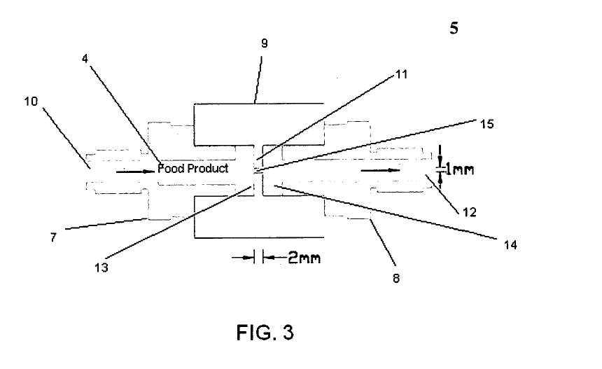

In a preferred embodiment of the invention two electrodes 7 and 8 are coupled to opposite sides of a insulator section 9 to form a specially designed RFEF treatment chamber 5 (See FIG. 3) that provides a uniform, high strength RFEF when the electrodes are attached to a RF power source 16.

The specialized RFEF chamber 5 is generally cylindrical in shape and can be divided into several sections. The first section of the chamber 5 is the first electrode 7, the second section is the insulator section 9, and the third section is the second electrode 8. The electrodes 7 and 8 are attached to the insulated section 9 using a threaded coupling, water proof adhesive or other attachment means capable of water tight seal. The two cylindrical electrodes 7 and 8, purchased from Swagelok Solon, US are constructed of stainless-steel and have a central apertures 10 and 12 running their respective lengths allowing fluid flow through the electrodes 7 and 8. Other suitable electrodes can also be used. The diameter of the central aperture of the electrodes or inner diameter (IDₑ) is 0.5 cm but can be adjusted for desired results. The distance between the two electrodes is approximately 8 mm but will vary according with pinch length and the length of the low field regions.

The insulator section 9 is generally cylindrical in shape and has a circular cavity (See, 13, 15 and 15) running its length. The insulator cavity is aligned with the central apertures 10 and 12 of the electrodes forming a continuous channel through the chamber 5. The insulator section 9 has at least one insulator pinch 11 which protrudes into the insulator cavity narrowing the diameter of the cavity along the length of the pinch 11. The insulator section 9 is constructed of, or manufactured from, an insulation material. Suitable insulation materials include but are not limited to acetyl homopolymers like DELRIN® (DuPont, Wilmington, Del.) and polystyrenes like REXOLITE® (C-LEC Plastics, Philadelphia, Pa.).

The insulator cavity is divided into a upstream low field region 13, a downstream low field region 14 and a high field pinch region 15 in between the low field regions. The diameter of the insulator cavity narrows as it transitions from the upstream low field region 13, to the insulator pinch 15. The diameter of the cavity 10 remains narrow along the length of the pinch region 15 and widens during the transition from the insulator pinch 15 to the downstream low field region 14. The diameter transitions from the upstream region 13 to pinch region 15, and from the pinch 15 region to the downstream region 14 shown in FIG. 3 are dramatic (around 90 degrees), however, a more gradual diameter transitions (less than 90°) can be envisioned. Dimensions of the cavity are described below in detail.

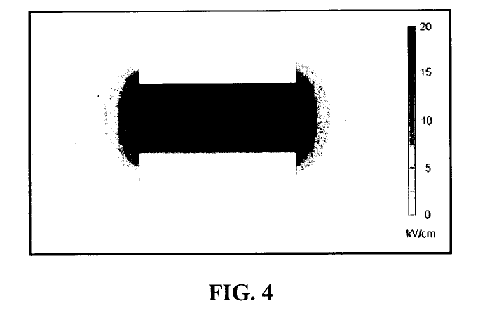

The narrow diameter of the cavity along the pinch results in the concentration of the RFEF in the pinch region 15. During operation, the pinch region 15 contains a high field strength while the upstream 13 and downstream 14 areas are generally low field regions. See FIG. 4.

The low field regions 13 and 14 are important because they reduce the potential for arcing within the chamber 5 by distancing the high field region from potential arcing point sources at the metal electrode and polymer insulator interfaces. The length of the low field regions (I_{lfr}) can vary, suitable lengths ranging from 1 mm to 15 mm. In FIG. 3 the length of the low field regions is approximately 1.1 cm. The low field regions 13 and 14 in FIG. 3 have a diameter greater than that of the inner diameter of the electrodes IDₑ which may also help prevent arching, however, a design wherein the inner diameter of the electrodes and low field regions are the same could also be envisioned.

Several other dimensions of the chamber 5 are important, especially the diameter of the insulator pinch (Dₚ) and the length of the insulator pinch (Iₚ). It was found that the ratio between the Iₚ and the Dₚ is important in determining the uniformity of the RFEF applied to the food product moving through RFEF chamber. Specifically, an increase in Ip and decrease in Dₚ both increase the uniformity of the RFEF. Thus an ideally uniform chamber would have a infinitely long pinch and Iₚ/Dₚ ratio of infinity. However, commercial constraints like increased pressure drops and decreased field strength prevent this from being practicable. A practical pinch length Iₚ is less than 3 cm and preferably less than 1.5 cm. The Iₚ in FIG. 3 is 0.2 cm. Uniformity is a critical aspect of the invention as it ensures that all of the food product is treated the same which makes the process safer, more efficient and less damaging to the food product.

Minimizing the diameter along the insulator pinch Dₚ to achieve uniformity is limited by factors such as the viscosity of feed stock and optimizing flow rate and flow dynamics within the chamber. Therefore the Dₚ should generally be between 0.05 cm and 3 cm. The Dₚ of the present pinch region is 0.1 cm.

Given these practical considerations, it was found that a suitable Iₚ/Dₚ ratio is between 1:1 and 3:1. The Iₚ/Dₚ of the present pinch region is 2:1.

The viscosity of the food product is suitably less than 20 μS/cm, preferably less than 10 μS/cm.

The pressure of the food product within the high field region is suitably greater than 5 psig, preferably greater than 20 psig.

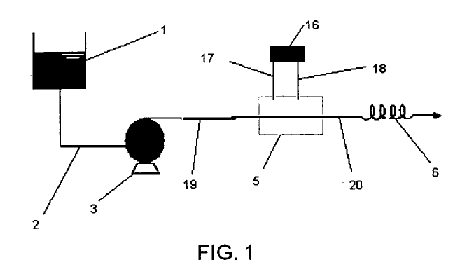

FIG. 1 is a schematic diagram of one of the preferred embodiments of the system. The described embodiment generally comprises a feed tank 1 (optional) a liquid pump 3, at least one RFEF treatment chamber 5, and a series of tubes connecting the systems various components 1, 19, 20). The joints connecting the various system components are ideally water tight to prevent any leaking. A heat exchanger 6 (or series of heat exchangers) can also be positioned to cool the food stock 4 upon exiting the treatment chamber 5. A second heat exchanger or heater (not shown) could be added to the system to regulate the inlet temperature of the food stock 4 entering the chamber 5.

The liquid food stock 4 is pumped from the feed tank 1 through the RF treatment chamber 5 (described earlier) where the food stock 4 is briefly exposed to a uniform RFEF having a specified field strength and frequency. The food stock 4 finally passes through a heat exchanger 6 that quickly cools the food stock to a specified temperature.

The feed tank 1 used in the present embodiment is an open top, cylindrical, stainless-steel tank. Feed tanks 1 of various sizes, shapes and volumes can also be used, but it is preferable that the tank 1 be constructed of a material suitable for holding liquid foods. If a closed-top tank is selected it will preferably have an inlet (not shown) for filling the tank with feed stock.

The feed tank 1 has at least one outlet (not shown), preferably located at, or near, the bottom of the tank to facilitate the flow of liquid out of the tank. The feed tank outlet is attached to the inlet end of the feed pump via a feed tube 2. The feed tube 2 can be fitted to the feed tank 1 outlet and feed pump inlet by various attachment means known in the art including but not limited to a threaded coupling or other water proof coupling device or material. The feed tank tube 2 in the present embodiment is constructed of Norene pump tubing, Model 06402-15 manufactured by (Cole-Parmer, Vernon Hills, Ill.), however, the various tubes of the system can be constructed of a variety of materials suitable for liquid food flow including but not limited to metal, rubber and plastic. The diameter of the system's connection tubes will vary with various aspects of the system including flow rate. The diameter of the tubes in FIG. 1 are 0.6 cm. The feed stock may be dearated to remove dissolved gases.

The presented feed pump 3 is a driver model 7523-40, head model 77200-62 peristaltic pump manufactured by (Cole-Parmer, Vernon Hills, Ill.), however, a myriad of other pumps could also be employed. The presented feed pump 3 produced a flow rate of approximately 550 ml/min through the feed tube 2, however, the flow rate can be adjusted according to desired results. Much higher flow rates are envisioned with appropriately larger pumps.

The feed pump 3, pumps the feed stock, through a connecting tube 19 and into the RFEF chamber where it is briefly exposed to high strength RFEF within the pinch region 15. The electrodes of the chamber 5 (previously described) are attached to an RF power supply 16 via to connection wires 17 and 18.

Treatment times can vary according to desired effectiveness. Suitable treatment times are under 0.01 second per cycle, preferably under 0.001 per cycle.

The temperature of the food product is slightly elevated during treatment the elevating in temperature caused by ohmic heating. While elevating the temperature of the liquid food being treated enhances the pasteurization ability of the system, the elevated temperatures can also adversely affect certain traits of the food including taste and nutrients. Therefore, it is important to maintain a temperature range which increases the effectiveness of pasteurization while limiting the negative heat effects on the food being treated. One can control the amount of heating by regulating the temperature of the food product prior to entering the treatment chamber using a heat exchanger and by controlling the treatment time to reduce ohmic heating. Negative effects of ohmic heating can also be limited by cooling the product upon exit of the treatment chamber.

Upon exiting the treatment chamber 5 the liquid food stock is preferably passed through a heat exchanger 6 (or series of second heat exchangers). The heat exchanger cools the feed stock 4 to a specified temperature, preferably less than 25° C. Quickly cooling the feed stock 4 after treatment reduces the negative effects of ohmic heating during treatment. One embodiment uses a stainless-steel heat exchanger submerged in a water bath. Other heat exchanger systems known in the art could also be employed. Suitable hold times are less than 4 minutes, preferable less than 1 minute.

The heat exchanger can be a stainless-steel coil. The system can optionally include a storage tank (not shown) for storing treated food stock 4 prior to use, packaging or transport.

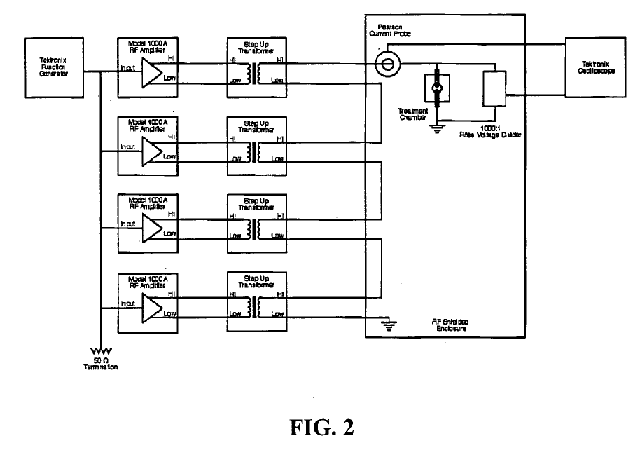

FIG. 2 describes an exemplary RF power supply system 16 that produces a peak voltage of 5.2 kV over a frequency range of 15-70 khz. The RF power supply system 16 comprises four 1-kW RF amplifiers, (Model 1000A, Industrial Test Products, Port Washington, N.Y.) and four step-up transformers (Industrial Test Products, Port Washington, N.Y.). These components are connected in series as shown in FIG. 2. A function generator (Model AFG 310, Tektronix, Beaverton, Oreg.) drove the amplifiers. The voltage input to the amplifiers and the voltage and current supplied to the RF treatment chamber were measure with an oscilloscope model TDS210 (Tektronix, Beaverton, Oreg.), a current probe model 411 (Pearson Electronics, Palo Alto, Calif.) and a voltage divider model VD15-8.3A-KB-A (Ross Engineering, Cambell Calif.). Other RF power supply systems capable of producing voltages (exemplary between 1 kV-100 kV, preferably between 4 kV and 30 kV) and frequencies within desired ranges (exemplary between 60 Hz and 100 kHz, preferably between 60 Hz and 25 kHz, more preferably less or equal to 20 kHz) can also be used.

### ALTERNATE EMBODIMENTS

Several alternate embodiments of the present invention can be envisioned including a scaled up version for commercialization. A commercialized system may incorporate several treatment chambers aligned in parallel as well as in series to increase volume and improve the effectiveness of the treatment. Other system components like RF power supply, feed tanks etc. may also be scaled up for commercial use.

Another embodiment includes combining the present system with various other treatment methods including chemical additives, heat pasteurization, as well as other non-thermal treatment techniques. Such combinations could increase deactivation of bacteria and increase the shelf life of various food products.

Test Set-Up, Procedures and Results

The output of the above described 5.2 kV RF power supply was connected to the electrodes of the treatment chamber. The central portion of the insulation section of the chamber consisted of a pinch region having a 0.1-cm diameter and a 0.2-cm length. Thus, the maximum electric field strength used in the study was 26 kV/cm obtained by dividing the peak voltage, 5.2 kV, by the length of the gap, 0.2 cm. A 0.3-cm space between the end of each of the electrodes and the pinch region prevented arcing. QuickField™ (Tera Analysis Ltd, Svendborg, Denmark) finite element analysis software was used to model the anisotropic AC current flow within the treatment chamber. FIG. 4 presents the model's results for an electric field strength of 18 kV/cm. The apple juice flows through the electrode and enters a low field region. It then flows into the pinch region where the field is quickly raised to 18 kV/cm. The field within the gap is nearly uniform, which ensures that all of the juice is treated equally. The uniformity improves the energy efficiency of the process. By minimizing the regions within the treatment chamber where the electric field is too low to inactivate bacteria and only heats the juice, approximately <5 kV/cm, the energy loss is minimized. Similarly, by minimizing the regions where the field is higher than needed to inactivate bacteria, the energy loss is minimized. Thus, the outlet temperature is lessened, and the apple juice is not over-treated.

The input voltage to the amplifiers and the supplied voltage and current to the RF treatment chamber were measured using an oscilloscope (model TDS210; Tektronix), current probe (model 411; Pearson Electronics, Palo Alto, Calif., U.S.A.), and a voltage divider (model VD15-8.3-A-KB-A; Ross Engineering, Campbell, Calif., U.S.A.).

The experimental system included a stainless-steel feed tank and a peristaltic pump (driver model 7523-40; head model 77200-62; Cole-Parmer, Vernon Hills, Ill., U.S.A.) that supplied the apple juice to the RFEF system at a flow rate of 550 mL/min through Norprene pump tubing (model 06402-15; Cole-Parmer). Turbulent flow within the treatment chamber (Reynolds. Number=12000) further improved the processing uniformity. The juice was exposed to intense RFEF for approximately 170 μs. At a frequency of 30 kHz, approximately 5 cycles would occur in 170 μs. The inlet temperature to the RF treatment chamber was controlled using a stainless steel heat exchanger (model SC004; Madden Manufacturing, Elkhart, Ind., U.S.A.) and a temperature controller (model CALL 9400; Cole-Parmer). The outlet temperature from the RF treatment chamber was 45° C., 50° C., or 55° C., depending on the experiment.

The temperatures of the apple juice immediately before and after the RFEF treatment chamber were measured with fiber-optic sensors (model 790; Luxtron, Santa Clara, Calif., U.S.A.). The temperatures were continuously logged to a data acquisition system (Dasylab version 5.0; Dasytec USA, Amherst, N.H., U.S.A.). The apple juice was quickly cooled after exiting the treatment chamber to <25° C. using a stainless-steel cooling coil submerged in a water bath. The length of time for the juice to travel from the treatment chamber to the cooling coil was approximately 4 s. In some cases, the effect of exposure to multiple treatment stages was desired, and the apple juice was reprocessed once or twice more, depending on the experiment. Product from the outlet of the cooler was collected in a carboy and was processed through the system a 2nd or 3rd time.

Controls were performed to determine the effect of temperature alone. The apple juice was heated to the desired temperature using the heat exchanger and then cooled using the cooling coil. The length of time for the juice to travel from the heat exchanger to the cooling coil was approximately 8 s. Each experiment was performed in duplicate. Results were expressed as the means of these values±standard deviations. The significance of differences in the RFEF results, based on the critical value of the Student t test, was calculated using Excel (Microsoft, Redmond, Wash.) statistical analysis algorithms.

Sampling and Analysis

Duplicate samples were taken of the products. Appropriate dilutions of the samples were plated on tryptose agar using a spiral plater (model Autoplate 4000; Spiral Biotech, Bethesda, Md., U.S.A.) and incubated at 37° C. for 24 h. Enumerations were made with a colony counter (model CASBA 4; Spiral Biotech).

Bacteria and Juice Inoculation

P. M. Fratamico, a lead scientist at the U.S. Dept. of Agriculture, Wyndmoor, Pa., U.S.A., supplied the E. coli K12 substrain C600 (Fratamico P M, Bhaduri S, Buchanan R L. 1993. Studies on Escherichia coli serotype 0157:H7 strains containing a 60-MDa plasmid and on 60-MDa plasmidcured derivatives. J Med Microbiol 39(5):371-81). The bacteria were maintained on tryptose agar (Difco Laboratories, Detroit, Mich., U.S.A.) at 4° C. The E. coli K12 was cultured in brain heart infusion (Difco Laboratories) for 24 h at 37° C. Apple juice (Brix approximately 12; viscosity approximately 1 cP (centi-poise) was purchased from a local store. A sample was analyzed for microorganisms and none were detected. The juice was inoculated from the stationary phase culture to give an approximately 4, 5, or 6 log colony-forming units (CFU)/mL population, depending on the experiment. The solution's pH was 4.0 and its conductivity was 2.1 mS/cm.

### RESULTS

Radio frequency electric fields successfully inactivated E. coli K12 in apple juice at nonthermal conditions. The extent of microbial inactivation is dependent on the electric field strength (up to 16 kV/cm), number of treatment stages, frequency, and temperature.

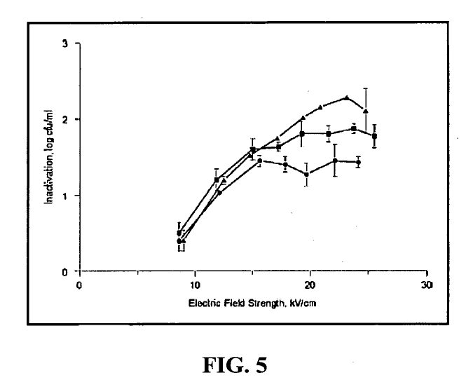

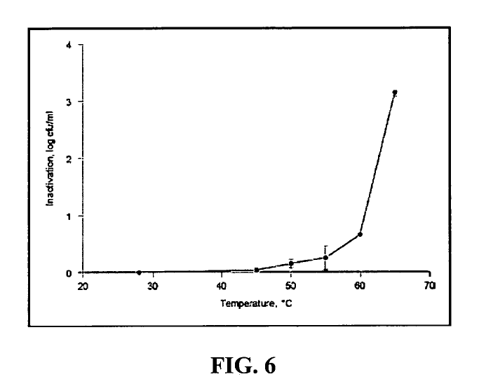

A series of experiments were performed at 20 kHz to determine the effects of electric field strength and temperature on inactivation. FIG. 5 shows that the population of E. coli in the apple juice was reduced by 1.4±0.1 log after being exposed to a 24 kV/cm peak electric field at a treatment chamber inlet temperature of 10° C. and outlet temperature of 45° C. The temperature increase in the RFEF treatment chamber was because of ohmic heating. When the electric field was eliminated and the inlet temperature was raised to match the outlet temperature, 45° C., the reduction was <0.1 log, as shown in FIG. 6. Applying an electric field of 24 kV/cm at an outlet temperature of 50° C. reduced E. coli by 1.9±0.1 log. The vast majority of this reduction was because of nonthermal effects considering that the control, which had a longer come-up and hold time, was only 0.2±0.1 log. The nonthermal inactivation is believed to be because of electroporation of the cells as a result of high electric fields. Geveke and Brunkhorst applied RFEF to S. cerevisiae in water, albeit with a different treatment chamber, and obtained an inactivation of 2.1±0.1 log at 30 kV/cm and 40° C. (Geveke D J, Brunkhorst C. 2003. Inactivation of Saccharomyces cerevisiae using radio frequency electric fields. J Food Prot 66(9):1712-5). The results of the present study, with a newly designed treatment chamber, extend the RFEF process to the inactivation of bacteria in fruit juice and other food products.

The results presented in FIG. 5 show that bacterial inactivation increased significantly as the electric field strength increased up to 16 kV/cm (critical value of Student t test, P<0.05).

However, inactivation remained constant with field strength above 16 kV/cm (P>0.1), especially at 45° C. and 50° C. Jayaram (Jayaram S, Castle G S P, Margaritis A. 1992. Kinetics of sterilization of Lactobacillus brevis cells by the application of high voltage pulses. Biotechnol Bioeng 40(11):1412-20) applied PEF to Lactobacillus brevis and observed similar behavior. Inactivation of L. brevis greatly increased with field strength up to 15 kV/cm, whereas, at higher fields, inactivation remained constant at temperatures between 30 and 45° C. Wouters and others (Wouters P C, Dutreux N, Smelt J P P M, Lelieveld H L M. 1999. Effects of pulsed electric fields on inactivation kinetics of Listeria innocua. Appl Environ Microbiol 65(12):5364-71.) reported similar results for PEF treatment of Listeria innocua except that the threshold field strength was higher, 30 kV/cm, and was observed between 45° C. and 60° C.

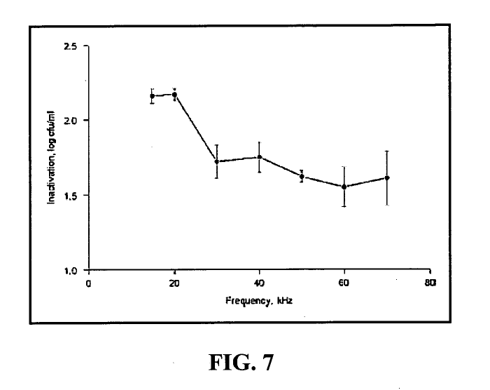

FIG. 7 shows the results of experiments conducted over the frequency range of 15 to 70 kHz, to determine the effect of frequency on inactivation. A 20 kV/cm electric field strength at a temperature of 50° C. was applied to E. coli. Significantly greater inactivation occurred at frequencies less than or equal to 20 kHz (P<0.01). The cause of this has yet to be determined. The inventors previously applied RFEF to S. cerevisiae in water at frequencies of 20, 40, and 60 kHz and concluded that frequency had no effect on inactivation. The variation in results may be because of the use of different microorganisms, media, or treatment chambers.

The effect of initial concentration on inactivation was studied. A 17 kV/cm electric field strength at a temperature of 45° C. was applied to E. coli having initial concentrations of 4.3, 5.4, and 6.2 log CFU/mL. The inactivations varied from 1.0 to 1.1 log and were not significantly different across the range of initial concentrations studied. (P>0.1). These results are in agreement with those of Zhang for PEF treatment of E. coli in ultra-filtrated simulated milk. Initial concentration, which ranged from 3 to 8 log CFU/ mL, had no effect on inactivation (applications for pulsed power technology. (Zhang Q, Qin B -L, Barbosa-Canovas G V, Swanson B G. 1995b. Inactivation of E. coli for food pasteurization by high-strength pulsed electric fields. J Food Proc Preserv 19(2):103-18.)

However, earlier Zhang and others found that PEF inactivation of S. cerevisiae in apple juice was inversely affected by the initial concentration over the span of 4 to 6 log CFU/mL (Zhang Q, Monsalve-Gonzalez A, Qin B -L, Barbosa-Canovas G V, Swanson B G. 1994. Inactivation of Saccharomyces cerevisiae in apple juice by square-wave and exponential-decay pulsed electric fields. J Food Proc Eng 17(4):469-78.). These results were attributed to a cluster protection mechanism. Recently, Damar and others inactivated E. coli in peptone solution at initial concentrations between 3 to 8 log CFU/mL with PEF (Damar S, Bozoglu F, Hizal M, Bayindirli A. 2002. Inactivation and injury of Escherichia coli 0157: H7 and Staphylococcus aureus by pulsed electric fields. World J Microbiol Biotechnol 18(1):1-6.). Inactivation was found to be inversely proportional to initial concentration and was presented as further support of a cluster protection mechanism. Once again, the discrepancy in results may be because of differences in the process parameters, microorganisms, or media used.

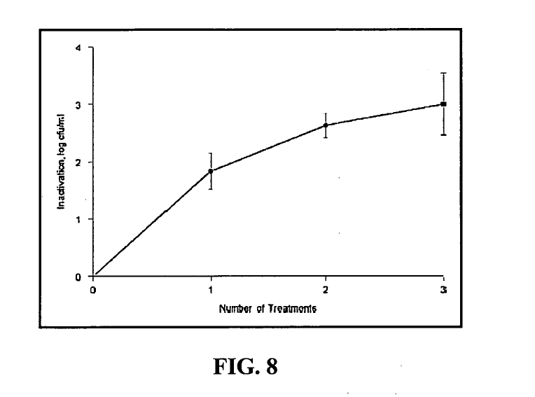

FIG. 8 shows that inactivation increased with increasing number of treatments stages (P<0.05). The juice was exposed to RFEF for approximately 170 μs during each stage. A single treatment of an 18 kV/cm electric field at 50° C. reduced the population of E. coli by 1.8±0.3 log, whereas three treatments reduced the population by a 3.0±0.5 log reduction. Inactivation of recycled material was less than that of untreated material. This may be because of the more RFEF-sensitive E. coli having already been eliminated in the 1^{st} treatment stage. Based on the flow rate, 550 mL/min, and the voltage and current measured by the oscilloscope, 2.5 kVrms and 0.36 Arms, respectively, the energy applied during each stage was 100 J/mL. From the inlet temperature, 30° C., the energy calculated to raise the temperature of the apple juice to 50° C. is 88 J/mL. This is in good agreement with the energy calculated using the current and voltage. For 3 treatment stages, the total energy was 300 J/mL. The estimated energy required for pasteurization using PEF ranges from 100 to 400 J/mL. Based on the U.S. Dept. of Energy's data for the average industrial electric price for 2002 of $0.047/kWh, the energy cost for the RFEF process was $0.015/gallon of apple juice. For comparison, conventional thermal pasteurization, with heat regeneration or recovery, requires only $0.002/gallon.

Example of 5 log Deactivation

Escherichia coli K12 was cultured in brain heart infusion for 24 h at 37° C. The culture was diluted with acidified water to yield a population of 8.6 log CFU/ml. The solution's pH was 4 and its conductivity was 4.4 mS/cm which are similar to those of orange juice.

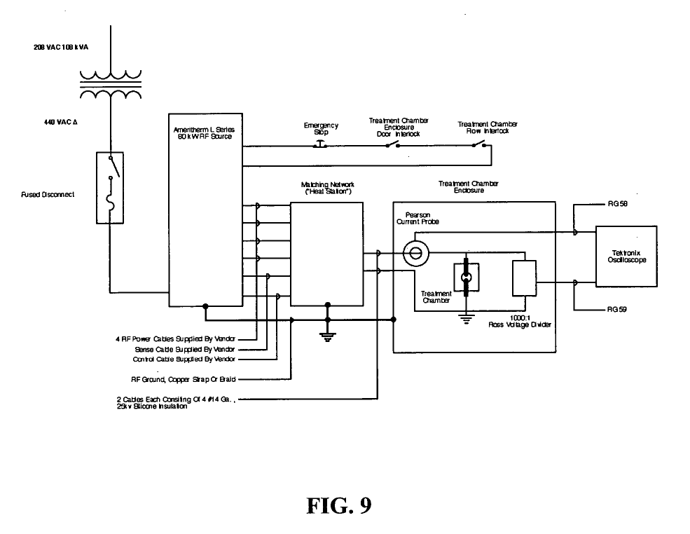

The solution was treated using a RF power supply (˜80 kW) (FIG. 9) and matching network at a frequency of 21.5 kHz. The diameter and length of the RFEF treatment chamber channel were 0.14 cm and 0.23 cm, respectively. A 0.20 cm space between the end of each of the electrodes and the central channel prevented arcing. The solution passed through two treatment chambers in series with intercooling between the chambers. The nominal maximum electric field strength used was 26 kV/cm.

The experimental system included a stainless steel feed tank and a progressing cavity pump that supplied the solution to the RFEF system at a flow rate of 1.6 l/min. The inlet temperature to each of the RFEF treatment chamber was controlled using a stainless-steel heat exchanger and a temperature controller. The temperatures of the solution immediately before and after the RFEF treatment chambers were measured with thermocouples. The temperatures were continuously logged to a data acquisition system. The inlet and outlet temperatures were 18 and 55° C. The solution was quickly cooled after exiting the final treatment chamber to less than 25° C. using a stainless-steel heat exchanger. The length of time for the solution to travel from the treatment chamber to the heat exchanger was 2 s. The solution returned to the feed tank where it was recycled.

Controls were performed to determine the effect of temperature alone. Appropriate dilutions of samples were plated on tryptose agar using a spiral plater and incubated at 37° C. for 24 h. RFEF processing inactivated Escherichia coli by 5.4 log (99.9996%) relative to the control as shown in Table 1

TABLE 1

| Treatment Cycles | Inactivation (log CFU/ml) |
|---|---|
| 0 (Control) | 0 |
| 1 | 3.6 |
| 2 | 4.4 |
| 3 | 5.4 |

Having described the basic concept of the invention, it will be apparent to those skilled in the art that the foregoing detailed disclosure is intended to be presented by way of example only, and is not limiting. Various alterations, improvements, and modifications are intended to be suggested and are within the scope and spirit of the present invention. Additionally, the recited order of the elements or sequences, or the use of numbers, letters or other designations therefore, is not intended to limit the claimed processes to any order except as may be specified in the claims. Accordingly, the invention is limited only by the following claims and equivalents thereto.

We claim the following to be our invention:

1. A radio frequency electric field (“RFEF”) treatment system for deactivating organisms in a pumpable food product, the system comprising:
at least one treatment chamber having an upstream electrode, a downstream electrode, and an insulator positioned between, and coupled to, the upstream and downstream electrodes, the insulator having a cavity of defined diameter running the length of the insulator cavity, the insulator having an upstream section, an insulator pinch, and a downstream section, the diameter of the insulator cavity along the length of the insulator pinch being narrower than the diameter of the cavity in the downstream and upstream sections;
a radio frequency power supply means for applying a voltage to the upstream and downstream electrodes forming a RFEF between the upstream and downstream electrodes, the RFEF having a specified strength and frequency.

2. The RFEF treatment system of claim 1, wherein the upstream and downstream electrodes have central apertures running their respective lengths.

3. The RFEF treatment system of claim 2, wherein the apertures of the upstream and downstream electrodes have a diameter between 0.1 cm and 2 cm.

4. The RFEF treatment system of claim 2, wherein the apertures of the upstream and downstream electrodes have a diameter of approximately 0.5 cm

5. The RFEF treatment system of claim 2, wherein the apertures of the electrodes are aligned with insulator cavity forming a continuous channel through the treatment chamber.

6. The RFEF treatment system of claim 1, wherein the electrodes are constructed of stainless steel.

7. The RFEF treatment system of claim 1, further comprising a flow means for pumping liquid food through the treatment system.

8. The RFEF treatment system of claim 1, further comprising a heat exchanger means for controlling the temperature of the liquid food product upon exit from the treatment chamber.

9. The RFEF treatment system of claim 1, wherein the treatment chamber is made of an acetyl homopolymer or polystyrene.

10. The RFEF treatment system of claim 1, wherein the insulator pinch has a length of between 0.15 cm and 2.54 cm.

11. The RFEF treatment system of claim 1, wherein the insulator pinch has a length of approximately 0.2 cm.

12. The RFEF treatment system of claim 1, wherein the diameter of the insulator cavity along the length of the insulator pinch is between 0.05 cm and 1.00 cm.

13. The RFEF treatment system of claim 1, wherein the diameter of the insulator cavity along the length of the insulator pinch is approximately 0.2 cm.

14. The RFEF treatment system of claim 1, wherein the ratio between length of the insulator pinch and the diameter of the insulator cavity along the length of the insulator pinch is between 1:1 and 3:1.

15. The RFEF treatment system of claim 1, wherein the ratio between the length of the insulator pinch and the diameter of the insulator cavity along the length of the insulator pinch is approximately 2:1.

16. The RFEF treatment system of claim 1, wherein the diameter of the insulator cavity along the upstream and downstream sections are approximately 1.1 cm.

17. The RFEF treatment system of claim 1, wherein the diameter of the insulator cavity along the upstream and downstream sections are between 0.1 cm and 3 cm.

18. The RFEF treatment system of claim 1, wherein the length of the upstream and downstream section of the insulator cavity is approximately 0.3 cm.

19. The RFEF treatment system of claim 1, wherein the length of the upstream and downstream section of the insulator cavity is between 0.1 cm and 2 cm.

20. The RFEF treatment system of claim 1, wherein the nominal peak field strength within the treatment chamber is greater than 10 kV/cm.

21. The RFEF treatment system of claim 1, wherein the nominal peak field strength within the treatment chamber is approximately 26 kV/cm.

22. The RFEF treatment system of claim 1, wherein the frequency of the RFEF is between 60 Hz and 100 kHz

23. The RFEF treatment system of claim 1, wherein the frequency of the RFEF is less than 30 kHz.

24. The RFEF treatment system of claim 1, wherein the frequency of the RFEF is less than or equal to approximately 20 kHz.

25. The RFEF treatment system of claim 1, wherein the pumpable food product is fruit juice.

26. The RFEF treatment system of claim 1, wherein the pumpable food product has a conductivity between 0 and 10 mS/cm.

27. The RFEF treatment system of claim 1, wherein the pumpable food product remains in treatment chamber for less than one second.

28. The RFEF treatment system of claim 1, wherein the pumpable food product has a temperature of less than 70° C. after passing through the treatment chamber.

29. The RFEF treatment system of claim 1, wherein the hold time is 1-240 s.

30. The RFEF treatment system of claim 1, wherein the pumpable food product has a viscosity of less than 10 cP (centi-poise).

31. The RFEF treatment system further comprising: a pump for flowing the pumpable product through the system at a predetermined flow rate.

32. A radio frequency electric field (“RFEF”) treatment system for deactivating organisms in a pumpable food product, the system comprising:
at least one treatment chamber having a first electrode, a second electrode, and an insulator positioned between, and coupled to, the first and second electrodes, the first and second electrodes having central apertures running their respective lengths
the insulator having a cavity of defined diameter running the length of the insulator cavity, the insulator having an upstream section, an insulator pinch, and a downstream section, the diameter of the insulator cavity along the insulator pinch being narrower than the diameter of the cavity in the downstream and upstream sections; wherein the apertures of the electrodes are aligned with insulator cavity forming a continuous channel through the treatment chamber
a power supply means for applying a voltage to the first and second electrodes forming a RFEF between the two electrodes, the RFEF having a specified strength and frequency.
A pumping means for pumping liquid food through the treatment chamber,
a heat exchanger, the heat exchanger connected to the second electrode via a chamber-heat exchanger connection means, the heat exchanger cooling the food product to a specified temperature upon exit of the treatment chamber.
